(19) United States
(12) Patent Application Publication
(10) Pub. No.: US 2016/0177871 A1
(43) Pub. Date: Jun. 23, 2016

(54) Cylinder Liner for an Engine Block

(71) Applicant: Caterpillar Inc., Peoria, IL (US)

(72) Inventors: Curtis Graham, Peoria, IL (US); Luis Vazquez, Peoria, IL (US)

(21) Appl. No.: 14/581,736

(22) Filed: Dec. 23, 2014

(51) Int. Cl. F02F 11/00; F02F 1/00

(52) U.S. Cl. CPC F02F 11/005; F02F 1/004

(57) ABSTRACT

A cylinder liner is provided that can prevent a band seal from being damaged during installation. The cylinder liner includes a pilot portion having a larger outer diameter than an outer diameter of the band seal. The pilot portion contacts an insert and a seal positioned on a recess of the engine block so that the cylinder liner lateral movement during operation of the engine block is prevented. In order to accommodate a larger outer diameter of the pilot portion, the inner diameters of the seal and insert can be correspondingly increased through a machining process. The machining process also creates uniform inner diameters of the seal and insert.

### TECHNICAL FIELD

This patent disclosure relates to an engine block and a cylinder liner and, more specifically an installable cylinder liner that is not damaged during installation.

### BACKGROUND

Many components of an internal combustion engine, such as a multi-cylinder diesel or gasoline engine are subjected to high loads and wear during operation of the engine. Once this component, for example, an engine block, which may experience loads from combustion events occurring within combustion chambers formed by the cylinder head, pistons, and cylinder bores of the engine block. These events may subject the engine block to high loads and stresses, including thermal stresses and mechanical stresses, which may be transmitted to the engine block at, among other locations, the cylinder head. As a result of the stresses, small cracks may form, or general wear may occur, within or near the cylinder bores of the engine block.

Each cylinder bore of an internal combustion engine may include a cylinder liner in which the piston reciprocates. Cylinder liners allows engine blocks with a particular bore configuration size to be used with multiple different diameter pistons by simply changing the cylinder liners for particularly configured engine. The liners may be held in place by a flange at the upper end and is disposed between the engine block in the cylinder head. The cylinder liners are configured to be removable and replaceable if worn due to use over a period of time.

U.S. Pat. No. 8,601,995 discloses a cylinder liner sealing arrangement for an internal combustion engine including a cylinder block having cylinder bores, a cylinder head, a cylinder liner within each cylinder bore and a circumferential cut-out formed in the upper and outer surfaces of the cylinder liner. A circular sealing ring is positioned in the circumferential cut-out with the sealing ring contacting at least the cylinder block and the cylinder liner to form a coolant seal there between. The sealing ring includes a seal enhancing configuration formed on at least an outer circumferential surface of the sealing ring with the seal enhancing configuration including at least one of an arcuate portion of a “D” ring seal or a plurality of circumferentially extending ribs. Abstract. However, the “D” ring seal may be cut during installation by a bore insert thereby potentially allowing fluids from fluid passages to leak into the cylinder bore.

Thus, there is a need for a cylinder liner and method to install the cylinder liner without inadvertently cutting a “D” band seal that surrounds the cylinder liner.

### SUMMARY

In some aspects of the disclosure, a cylinder liner used in an engine block includes a cylinder liner wall that defines a cylinder liner bore, a flange at an end of the cylinder liner wall configured to mate with an insert on the engine block, a band seal configured to be received in a band receiving portion of the cylinder liner wall, the band seal having a band seal outer diameter, and a pilot portion of the cylinder liner wall configured to be in contact with the insert and a seal on the engine block, the pilot portion having an outer diameter that is larger than the band seal outer diameter.

In some aspects, a method of installing a cylinder liner in an engine block includes the steps of providing a cylinder liner having a cylinder bore defined by a cylinder liner wall, the cylinder liner wall includes a pilot portion and band receiving portion, forming the pilot portion so that an outer diameter of the pilot portion is larger than an outer diameter of a band seal installed on the band receiving portion, and inserting the cylinder liner in the engine block without the outer diameter of the band seal coming into contact with an insert of the engine block.

In other aspects, an engine block having a cylinder liner that includes a cylinder bore that receives the cylinder liner, the cylinder liner includes a cylinder liner wall that defines a cylinder liner bore, a flange at an end of the cylinder liner wall, a band seal configured to be received in a band receiving portion of the cylinder liner wall, the band seal having a band seal outer diameter, and a locating feature of the cylinder liner wall configured to be in contact with an insert and a seal on the engine block, the locating feature having an outer diameter that is larger than the band seal outer diameter, the engine block also includes a recess that surrounds a top portion of the cylinder bore, wherein the seal is received in the recess and the insert is configured to mate with the flange, the insert positioned above the seal in the recess, and fluid passages having a fluid to cool the engine block.

### BRIEF DESCRIPTION OF THE DRAWINGS

FIG. 1 is a perspective view of an exemplary engine block according to an aspect of the disclosure.

FIG. 2 is a partial plan view of a top deck of the engine block of FIG. 1 according to an aspect of the disclosure.

FIG. 3 is a partial cross-sectional view of the engine block of FIG. 1 showing a prior art cylinder liner having a band seal.

FIGS. 4A and 4B are a partial cross-sectional view of an engine block during an installation of the cylinder liner in accordance with an aspect of the disclosure.

FIG. 5 is a partial cross-sectional view of an engine block having the cylinder liner installed in accordance with an aspect of the disclosure.

### DETAILED DESCRIPTION

The disclosure generally relates to a cylinder liner for use in a remanufactured engine block or a modified engine block. The disclosed cylinder liner may be utilized in a remanufactured engine block that has been used in the field or in a modified engine block as disclosed according to an aspect of the disclosure.

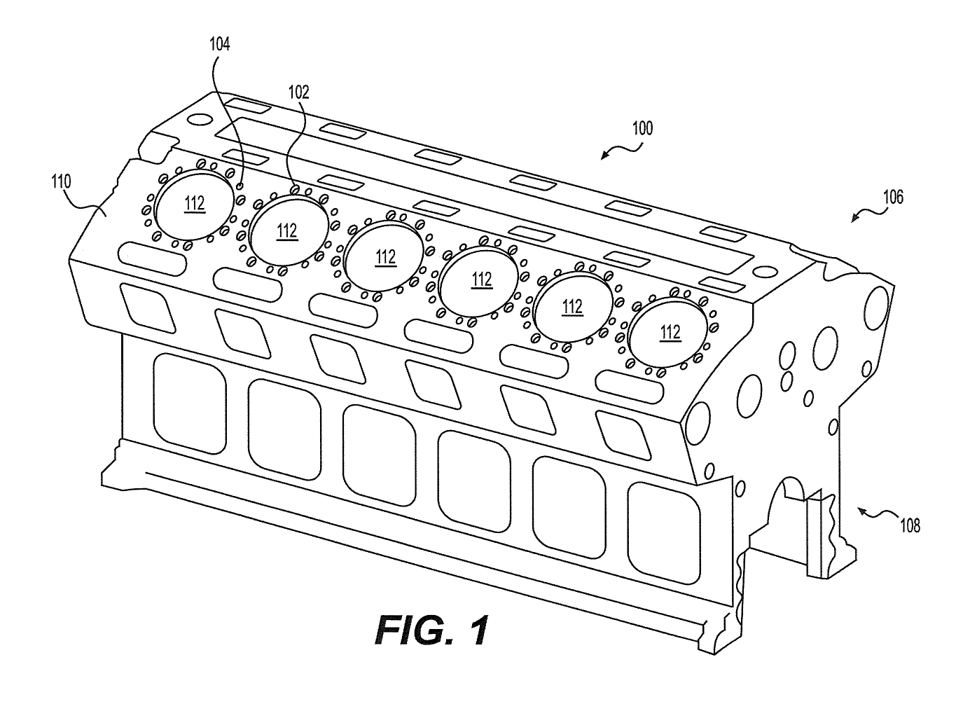

FIG. 1 is a perspective view of an exemplary engine block 100 according to an aspect of the disclosure. The engine block 100 can also be referred to as a cylinder block. The engine block 100 may, for example, be constructed of cast iron, aluminum, magnesium, stainless steel, or any other suitable material. The engine block 100 may be used in compression ignition engines or a spark ignited engines that are utilized to power on-highway or off-highway machine, stationery equipment, or any other machine or vehicle.

The engine block 100 may be made from a one-piece casting and may include an upper section 106 and a lower section 108. The upper section 106 may include a variety of openings on a top deck 110, such as cylinder bores 112, attachment bores 102, and fluid passages 104. Although six-cylinder bores 112 are shown, it should be appreciated that engine block 100 may include any number of cylinder bores 112 depending on the configuration of the engine being utilized.

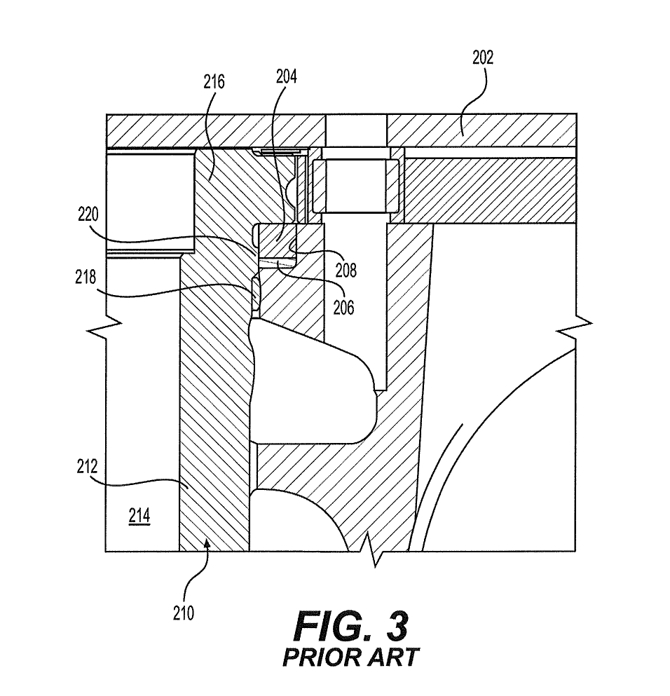

A cylinder head 202 (FIG. 3) may be attached to the engine block 100 by using, for example, a plurality of attaching bolts received within the corresponding number of attachment bores 102. The cylinder head 202 may seal each of the cylinder bores 112 and thus, creating combustion chambers within the engine block 100 and also provide a structure for supporting intake and exhaust valves, and/or ports, fuel injectors, necessary linkages, and other components that are used to combust the fuel.

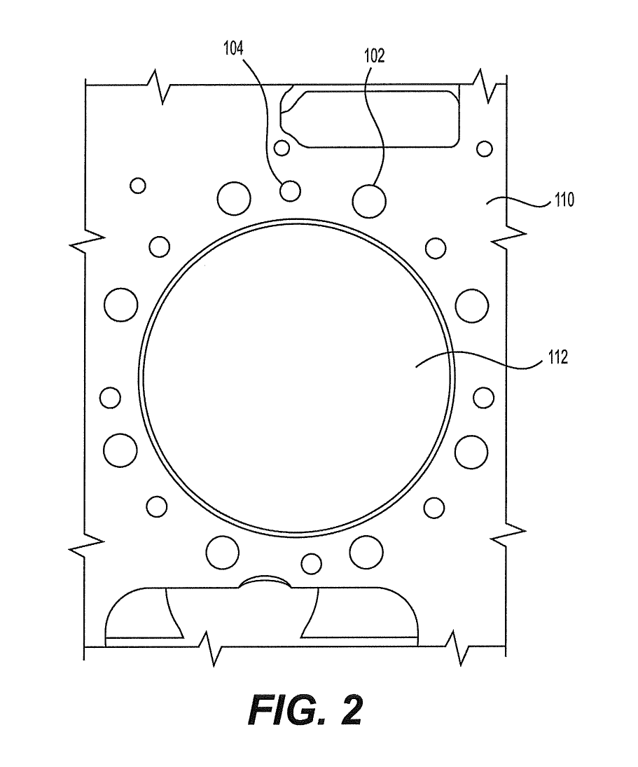

As shown in FIGS. 1 and 2, the upper section 106 of the engine block 100 may also include a plurality of fluid passages 104 such as water passages, circumferentially spaced around each cylinder bore 112. Any number of fluid passages may be provided throughout the engine block 100 and may be formed within the inner portion of the engine block 100 (lower section 108 and upper section 106) and may open through the top deck 110. The fluid passages 104 may form a water jacket or other similar cooling system for controlling circulation of cooling fluids and provide proper cooling of the engine block 100.

FIG. 2 is a partial plan view of a top deck 110 of the engine block 100 of FIG. 1 according to an aspect of the disclosure. The top deck 110 may include cylinder bores 112 surrounded by attachment bores 102 and fluid passages 104. During operation of an internal combustion engine, wear or erosion may occur at or adjacent to the edges of the cylinder bores 112 along the top deck 110. In addition, or alternatively, one or more defects or cracks may form within the top deck 110 during operation of the engine, or form during the original manufacturing of the engine. These defects and/or cracks in the engine block 100 may be repaired in a remanufacturing process. During the remanufacturing process, material including worn material, defects and/or cracks from the top deck 110, the attachment bores 102 and fluid passages may be removed creating recesses that surround the cylinder bores 112 located in the top deck 110. Material may be removed during the manufacturing using any known machining process, such as milling or grinding using a CNC (computer numerical control) process. As used herein, “remanufacturing” may refer broadly to the remanufactured, repair, or other similar process associated with restoring the engine block 100 to a working order.

FIG. 3 is a partial cross-sectional view of the engine block 100 of FIG. 1 showing a prior art cylinder liner 210 having a band seal 218. An insert 204 is shown positioned on a seal 206 both of which are received within a recess 208. The insert 204 may be retained within the recess 208 using an interference fit. The insert 204 may include a ring-shaped body having a central opening matching or aligned with, the cylinder bore 112. The recess 208 may be formed during the remanufacturing process by removing material from the cylinder bore 112. The insert 204 may be made from an alloy. The seal 206 may be made of a metal and a rubber portion. A pilot portion 220 may be provided to mate with the insert 204 and seal 206.

The prior art cylinder liner 210 may include a body 212 that defines a generally cylindrical shaped hole 214 in which a piston reciprocates. A flange 216 of the prior art cylinder liner 210 is provided to mate with the insert 204. A band seal 218 may be provided on the outer surface of the prior art cylinder liner 210 and be configured to extend into engagement with a wall of the cylinder bore 112. The band seal 218 helps to prevent any fluid from flowing in the space between the prior art cylinder liner 210 and the cylinder bore 112. During installation of the prior art cylinder liner 210, the band seal 218 may be cut by a sharp edge of the insert 204 or by the metal portion of the seal 206 due to an even surface created by the coupling of the insert 204 and seal 206. If the band seal 218 is cut, fluid may enter the cylinder bore 112 and effect combustion event that occurs therein. In the undeformed state, the outer diameter of the band seal 218 is larger than the outer diameter of the prior art cylinder liner 210 at the pilot portion.

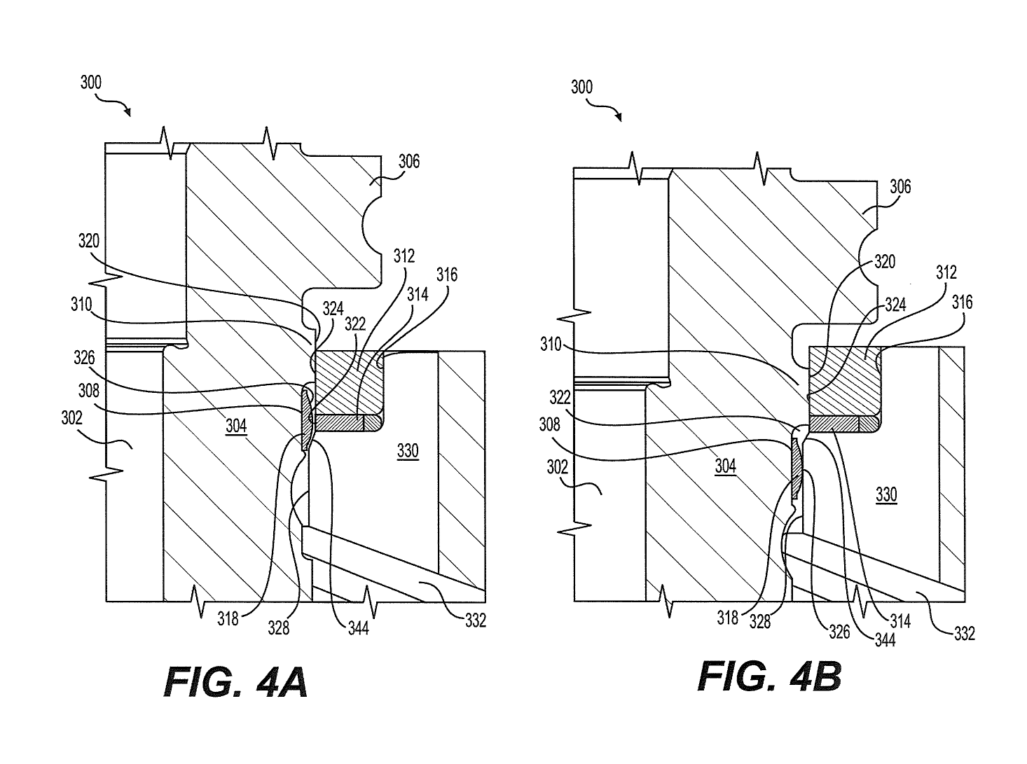

FIGS. 4A and 4B are partial cross-sectional views of an engine block 330 during an installation of the cylinder liner 300 in accordance with an aspect of the disclosure. The cylinder liner 300 includes cylinder liner bore 302 in which a piston may reciprocates, a cylinder liner wall 304 and a cylinder liner flange 306, a band receiving portion 308 that receives a “D” band seal 318, and a pilot portion 310.

The “D” band seal 318 is configured to seal and prevent any fluids from inner fluid passages 332 from entering the cylinder liner bore 302. The “D” band seal includes an outer diameter 326 that mates with an inner diameter 328 of the engine block 330 to form the seal. The “D” band seal can be made from any elastomeric material such as coolant resistant fluorocarbon rubber (FKM) so that the outer diameter 326 is deformable (See FIG. 4B) during installation but still can form a proper seal.

Located on the engine block 330 are insert 312, seal 314, and inner fluid passages 332. The insert 312 and seal 314 are both positioned in the recess 316. The recess 316 may be previously formed in the engine block 330 or can be created by machining during the remanufacturing process. During the machining process of the recess or afterwards, a chamfer 344 can be created. The chamfer 344 is designed to reduce any sharp edges that may be produced during the machining of the recess 316. Additionally, the chamfer 344 will help the “D” band seal 318 to start to become deformed during the cylinder liner installation. The insert 312 may generally be a ring shaped body having a central opening matching, or aligned with, the cylinder bore 112 and an insert inner diameter 324 that mates with an outer diameter 320 of the cylinder liner 300 at the pilot portion 310. The insert 312 may be retained within the recess 316 using any retention method, such as interference fit. The insert 312 may be made from any material including an alloy, such as hardened stainless steel (SAE 51416).

Located below the insert 312 is seal 314, both of which are received within the recess 316. The seal 314 can be made from two different materials, such as metal (carbon steel SAE 1008) and rubber (EPDM, ethylene propylene diene). The seal 314 includes a seal inner diameter 322 that also mates with the outer diameter 320 of the cylinder liner 300 at the pilot portion 310. In one aspect of the disclosure, the seal inner diameter 322 and the insert inner diameter 324 are flush (or generally flush) with each other so that they do not cut the “D” band seal 318 during installation. Further, the outer diameter 320 at the pilot portion 310 is also known as a location feature. Because the outer diameter 320 at the pilot portion 310 is in contact with the insert inner diameter 324 and the seal inner diameter 322, lateral movements by the cylinder liner 300 during engine operation are minimized.

In another aspect of the disclosure, the outer diameter 320 of the pilot portion 310 is increased relative to the outer diameter of the pilot portion 220 of the prior art cylinder liner 210. The pilot portion 310 can be increased during the production of the cylinder liner 300. Correspondingly, the seal inner diameter 322 and the insert inner diameter 324 would have to increase to accommodate the increase of the outer diameter 320 of the pilot portion 310. The seal inner diameter 322 and the insert inner diameter 324 can be increased using computer numerical control (CNC) machining systems. The increased outer diameter 320 of the pilot portion 310 should substantially be similar to the increase of the seal inner diameter 322 and the insert inner diameter 324. Otherwise, lateral movements of the cylinder liner 300 (during engine operations) may occur if the outer diameter 320 is not flush or be in constant contact with the seal inner diameter 322 and the insert inner diameter 324 when the cylinder liner is fully installed. By increasing the outer diameter 320 beyond the outer diameter 326 of the “D” band seal 318 that is in the non-deformed state, the “D” band seal 318 will be protected during the cylinder liner installation. That is, during cylinder liner installation, the outer diameter 326 of the “D” band seal 318 will not come into contact with either the seal inner diameter 322 or the insert inner diameter 324 (See FIG. 4A) and thus, but not be cut or damaged during installation.

In addition to or alternatively in accordance with another aspect of the disclosure, the engine block can also be machined to accommodate the increase in the outer diameter 320. For example, the recess 316 may be machined to remove materials in order to accommodate the increase in diameter of the outer diameter 320, which can cause insert 312 and the seal 314 to shift accordingly. That is, the recess 316 can be machined to accommodate substantially or correspondingly the same change in diameter as the outer diameter 320. Further, in another aspect of the disclosure, the increase of the recess 316 space laterally can be done during the manufacture of the engine block 330.

Thus, at the beginning of the installation as shown in FIG. 4A, the outer diameter 320 of the pilot portion 310 engages the insert inner diameter 324 of the insert 312 but does not engage the inner diameter 322 of the seal 314. Further, the outer diameter 326 of the “D” band seal 318 is in the non-deformed state and does not come into contact with either the insert inner diameter 324 or the seal inner diameter 322 due to the increased in diameter of the outer diameter 320. As shown in FIG. 4B, the outer diameter 320 of the pilot portion 310 engages both the insert inner diameter 324 and the seal inner diameter 322. Further, outer diameter 326 of the “D” seal band is in the deformed state and engages with inner diameter 328 of the block 330 and seals that portion of the cylinder block 330.

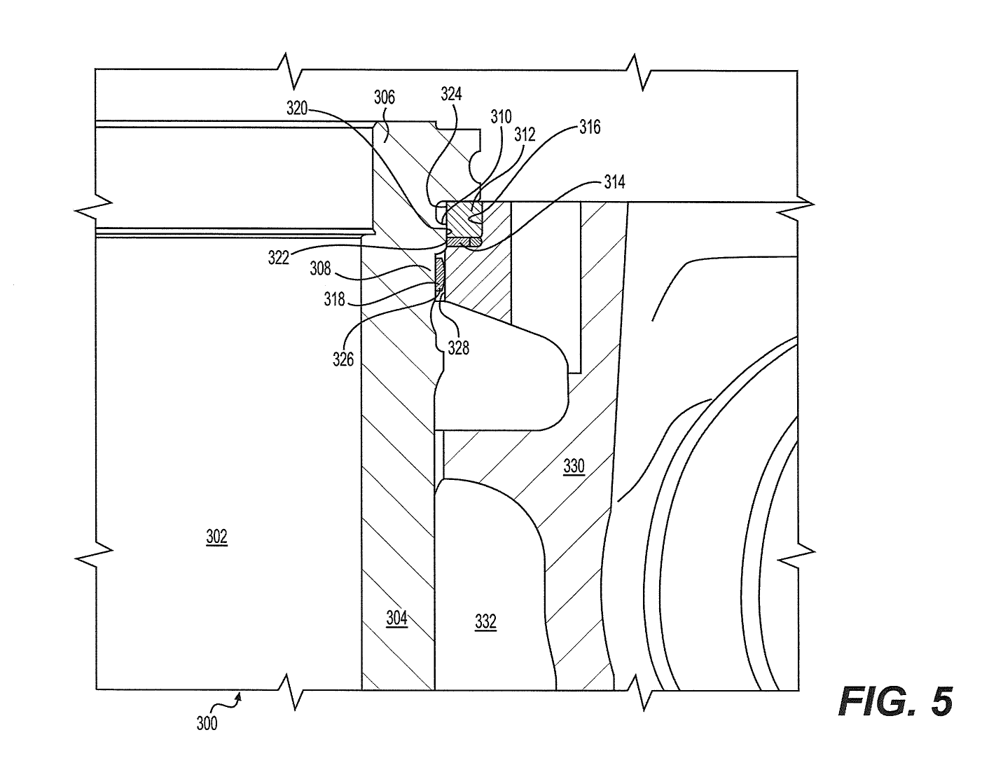

FIG. 5 is a partial cross-sectional view of an engine block 330 having the cylinder liner 300 installed in accordance with an aspect of the disclosure. As shown, the flange 306 of the cylinder liner 300 is in contact with the insert 312 when the cylinder liner is installed. The outer diameter 326 of the “D” band seal 318 is in the deformed state and engages with inner diameter 328 of the engine block 330 and seals that portion of the engine block 330. Thus, fluid from the inner fluid passages 332 are prevented from entering the cylinder liner bore 302. Further, the outer diameter 320 of the pilot portion 310 engages both the insert inner diameter 324 and the inner diameter 322 of the seal 314.

### INDUSTRIAL APPLICABILITY

As one of ordinary skill the art can appreciate after reviewing this disclosure, by increasing an outer diameter of the pilot portion and correspondingly the inner diameters of both the insert and seal helps to prevent the “D” band seal from being cut or damaged during the cylinder liner installation. The increased outer diameter of the pilot portion will cause an “overhang” of the “D” band seal to protect it during installation. That is, the increase in the outer diameter of the pilot portion along with the corresponding increase in the inner diameters of both the insert and seal will allow the “D” band seal to have a clearance so that the “D” band seal does not come into contact with either the insert inner diameter or the seal inner diameter. Further, by machining both the inner diameters of the liner and seal, both inner diameters will be more uniform and thus eliminating any sharp edges due to non-alignment of the inner diameters of the insert and seal.

The aspects of the disclosure can be used in new engine blocks or in remanufactured engine blocks. The cylinder liner can be manufactured with the increased outer diameter at the pilot portion and then using remanufacturing techniques, such as machining or milling the inner diameters of the insert and the seal can correspondingly increase with the increase in the outer diameter of the pilot portion. The remanufacturing can be done in the field.

The many features and advantages of the disclosure are apparent from the detailed specification, and thus, it is intended by the appended claims to cover all such features and advantages of the disclosure, which fall within the true spirit and scope of the disclosure. Further, since numerous modifications and variations will readily occur to those skilled in the art, it is not desired to limit the invention to the exact construction and operation illustrated and described, and accordingly, all suitable modifications and equivalents may be resorted to, falling within the scope of the disclosure.

We claim:

1. A cylinder liner used in an engine block, comprising:
a cylinder liner wall that defines a cylinder liner bore;
a flange at an end of the cylinder liner wall configured to mate with an insert on the engine block;
a band seal configured to be received in a band receiving portion of the cylinder liner wall, the band seal having a band seal outer diameter; and
a pilot portion of the cylinder liner wall configured to be in contact with the insert and a seal on the engine block, the pilot portion having an outer diameter that is larger than the band seal outer diameter.

2. The liner of claim 1, wherein the outer diameter of the pilot portion being larger than the band seal outer diameter prevents the band seal outer diameter from contacting the insert or the seal on the engine block.

3. The liner of claim 1, wherein the pilot portion being in contact with the insert and seal prevents a lateral movement of the cylinder liner during an operation of the engine block.

4. The liner claim 1, wherein the band seal outer diameter is configured to not contact either the insert or the seal during installation of the cylinder liner.

5. The liner of claim 1, wherein the band seal is a D band seal.

6. The liner of claim 5, wherein the D band seal is deformable during installation.

7. The liner of claim 1, wherein the seal is made from a carbon steel and ethylene propylene diene.

8. The liner of claim 1, wherein the insert is a hardened stainless steel.

9. The liner of claim 6, wherein the D band seal deforms during installation when the band seal outer diameter comes into contact with a chamfer of the engine block.

10. An engine block having a cylinder liner, comprising:
a cylinder bore that receives the cylinder liner, the cylinder liner comprising:
a cylinder liner wall that defines a cylinder liner bore;
a flange at an end of the cylinder liner wall;
a band seal configured to be received in a band receiving portion of the cylinder liner wall, the band seal having a band seal outer diameter; and
a locating feature of the cylinder liner wall configured to be in contact with an insert and a seal on the engine block, the locating feature having an outer diameter that is larger than the band seal outer diameter;
a recess that surrounds a top portion of the cylinder bore, wherein the seal is received in the recess and the insert is configured to mate with the flange, the insert positioned above the seal in the recess; and
fluid passages having a fluid to cool the engine block.

11. The engine block of claim 10, wherein the outer diameter of the locating feature being larger than the band seal outer diameter prevents the band seal outer diameter from contacting the insert or the seal on the engine block during installation.

12. The engine block of claim 10, wherein the locating feature being in contact with the insert and seal prevents a lateral movement of the cylinder liner during an operation of the engine block.

13. The engine block of claim 10, wherein the band seal outer diameter is configured to not contact either the insert or the seal during installation of the cylinder liner.

14. The engine block of claim 10, wherein the band seal is a D band seal.

15. The engine block of claim 14, wherein the D band seal is deformable during installation.

16. The engine block of claim 10, wherein the engine block further comprising:
a chamfer located below the insert and the seal.

17. The engine block of claim 16, wherein the D band seal deforms during installation when the band seal outer diameter comes into contact with the chamfer of the engine block.

18. The engine block of claim 10, wherein the seal is made from a carbon steel and ethylene propylene diene.

19. The engine block of claim 10, wherein the insert is a hardened stainless steel.

20. The engine block of claim 10, wherein a chamfer is created using a machining process.
